(19) United States
(12) Patent Application Publication
(10) Pub. No.: US 2025/0076677 A1
(43) Pub. Date: Mar. 6, 2025

(54) RIGID SHEET WITH FLEXIBLE PORTION

(71) Applicant: BRENT SHELDON, MIAMI, FL (US)

(72) Inventors: BRENT SHELDON, MIAMI, FL (US); GUY BROUSSEAU, JR., MARIEVILLE (CA)

(21) Appl. No.: 18/950,243

(22) Filed: Nov. 18, 2024

Related U.S. Application Data
(63) Continuation of application No. PCT/CA2023/050682, filed on May 17, 2023.
(60) Provisional application No. 63/413,421, filed on Oct. 5, 2022.
(60) Provisional application No. 63/343,154, filed on May 18, 2022.

(51) Int. Cl. G02C 1/02; B29D 12/02; G02C 5/08

(52) U.S. Cl. CPC G02C 1/02; B29D 12/02; G02C 5/08; G02C 2200/14; G02C 2202/16

(57) ABSTRACT

A composite sheet material is provided. The composite sheet material includes a rigid portion that defines an opening. The composite sheet material further includes a flexible material received within the opening and adapted to attach with the rigid portion to form a flexible portion of the sheet material.

### CROSS-REFERENCE TO RELATED APPLICATIONS

This application is a Continuation of PCT Application No. PCT/CA2023/050682 filed on May 17, 2023, which claims priority to U.S. Provisional Patent Application No. 63/343,154 filed on May 18, 2022, and also claims priority to U.S. Provisional Patent Application No. 63/413,421 filed on Oct. 5, 2022, the contents of which are incorporated herein by reference in their entirety.

### TECHNICAL FIELD

The following generally relates to materials prepared and/or used to construct items, particularly to sheet-like materials that include both rigid and flexible portions.

### BACKGROUND

Finished products that are constructed from multiple materials can be challenging to assemble, particularly when the materials need to be sized, aligned, and bonded to each other in an assembly process. While injection molding, overmolding, deposition, welding, and various other processes exist, these processes may require additional machinery, set-up, and assembly operations to construct the finished product.

### SUMMARY

In one aspect, a sheet material is provided. The sheet material includes a rigid portion defining an opening and a flexible material received within the opening. The flexible material is adapted to attach with the rigid portion to form a flexible portion of the sheet material.

In another aspect, a composite sheet material for constructing a product is provided. The composite sheet material includes a first rigid panel and a second rigid panel spaced apart from the first rigid panel to define an open space therebetween. The composite sheet material further includes a flexible material received in the open space and adapted to attach to each of the first and second rigid panels for coupling the rigid panels together. The flexible material forms a flexible portion of the composite sheet material to provide flexibility to the product constructed using the composite sheet material.

In a yet another aspect, a method for making a composite sheet material is provided. The method includes providing a first rigid panel and a second rigid panel spaced apart to define an open space therebetween. The method further includes filling the open space with a flexible material adapted to attach to each of the first and second rigid panels. The flexible material filled within the open space forms a flexible portion of the sheet material to provide flexibility to the product constructed using the composite sheet material.

In a yet another aspect, a method of constructing an eyewear from a composite sheet material is provided. The eyewear includes a first lens holder and a second lens holder coupled to the first lens holder via a bridge portion. The method includes providing the composite sheet material including a first rigid panel and a second rigid panel coupled to the first rigid panel via a flexible material. The method further includes applying a template for the eyewear over the composite sheet material such that the bridge portion of the eyewear template aligns with the flexible material of the composite sheet material. The method includes processing the composite sheet material according to the template to extract the eyewear having the first lens holder and the second lens holder made from the rigid panels of the composite sheet material and the bridge portion made from the flexible material of the composite sheet material.

### BRIEF DESCRIPTION OF THE DRAWINGS

Embodiments will now be described with reference to the appended drawings wherein:

FIG. 1 is a perspective view of a rigid sheet material with flexible portion.

FIG. 2 is a plan view of the rigid sheet material of FIG. 1.

FIG. 3 is a profile view of the rigid sheet of FIG. 1.

FIG. 4 is a perspective view of the rigid sheet of FIG. 1 being flexed at the flexible portion.

FIG. 5 is a profile view of the rigid sheet of FIG. 1 being flexed at the flexible portion.

FIG. 6 is a perspective view of a rigid sheet material with flexible portion in another configuration.

FIG. 7 is a plan view of the rigid sheet material of FIG. 5.

FIG. 8 is a profile view of the rigid sheet of FIG. 5.

FIG. 9 is a perspective view of the rigid sheet of FIG. 5 being flexed at the flexible portion.

FIG. 10 is a profile view of the rigid sheet of FIG. 5 being flexed at the flexible portion.

FIG. 11 is a perspective view of a rigid sheet material with flexible portion in another configuration.

FIG. 12 is a plan view of the rigid sheet material of FIG. 11.

FIG. 13 is a profile view of the rigid sheet of FIG. 11.

FIG. 14 is a perspective view of the rigid sheet of FIG. 11 being flexed at the flexible portion.

FIG. 15 is a profile view of the rigid sheet of FIG. 11 being flexed at the flexible portion.

FIG. 16 is a perspective view of a rigid sheet material with flexible portion in another configuration.

FIG. 17 is a plan view of the rigid sheet material of FIG. 16.

FIG. 18 is a profile view of the rigid sheet of FIG. 16.

FIG. 19 is a plan view of a rigid sheet with flexible portion with patterns being aligned to impart both rigid and flexible portions to the object to be cut from the sheet.

FIG. 20 is a front view of an eyewear frame portion cut from the sheet of FIG. 19.

FIG. 21 is a profile view of the eyewear frame portion of FIG. 20 being flexed at the flexible portion.

FIG. 22 is a plan view of a rigid sheet with flexible portion located in a central location of a single panel.

FIG. 23 is a profile view of the rigid sheet of FIG. 22.

FIG. 24 is a plan view of the rigid sheet of FIG. 22 with an eyewear pattern being aligned with the central flexible portion.

FIG. 25 is a plan view of the eyewear pattern of FIG. 24 applied to a rigid sheet as shown in FIGS. 1-21.

### DETAILED DESCRIPTION

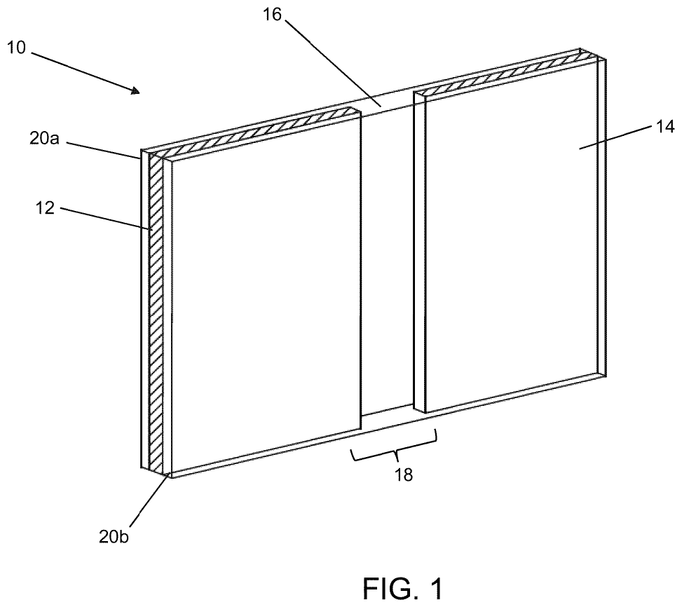

Turning now to the figures, FIG. 1 illustrates one example of a hybrid or composite sheet of material, referred to herein interchangeably as the “sheet” using reference numeral “10”. The sheet 10 includes multiple materials integrally formed and/or bonded together to provide at least one flexible portion or area and at least one rigid portion or area. In this way, a product cut or machined from the sheet 10 can inherit both rigid and flexible portions/areas by virtue of being extracted from the sheet 10 in a particular configuration, alignment, and orientation.

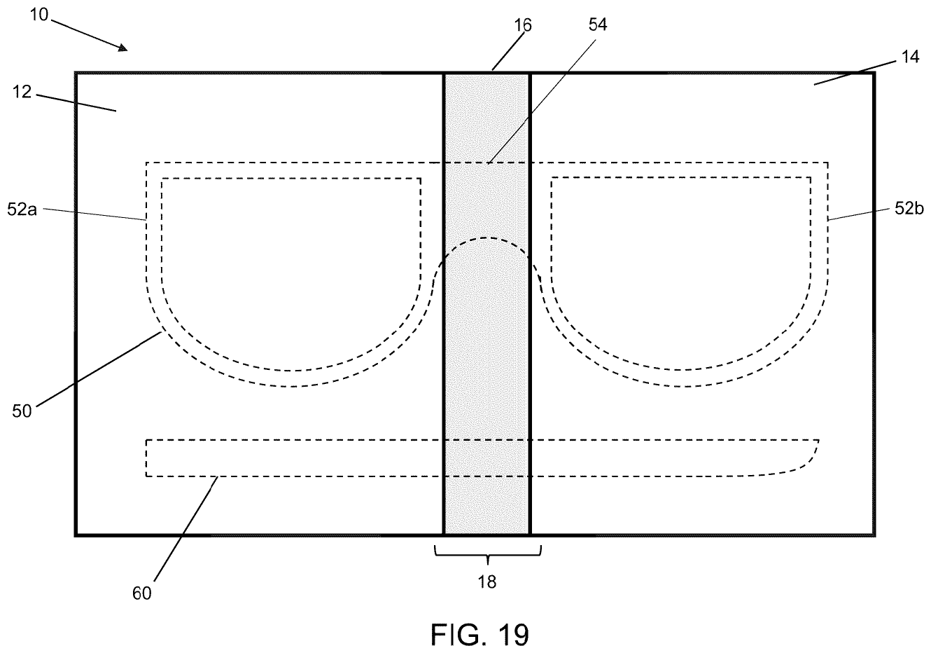

In one example, such as that shown in FIG. 1, the sheet 10 includes a first rigid panel 12 and a second rigid panel 14 that are spaced apart from each other to define an open space therebetween. The sheet material 10 further includes a flexible material 16 that is received into the open space to bond or join with the rigid panels 12, 14 and couple the two together, thereby forming a partially rigid layer within the sheet 10. The flexible material 16 extending and coupled between the rigid panels 12, 14 forms a flexible portion 18 of the sheet 10 to provide flexibility to any product that is constructed using the sheet 10. In some implementations, the panels 12, 14 can also be embodied as layers, and when aligned as shown in FIG. 1, can form a discontinuous layer with the flexible material 16 filling the void or break or the open space between the panels 12, 14. In the break, void, or gap between the rigid panels 12, 14 is the flexible portion 18 formed from adding the flexible material 16. In this example, the flexible portion 18 creates a flexible transverse strip across the sheet 10, however, it can be appreciated that the flexible portion 18 could be formed along any extent of the area between the rigid panels 12, 14. For example, the rigid panels 12, 14 could be joined above and/or below a centrally located flexible portion (forming an opening or aperture rather than a channel), such as shown in FIG. 19 described below.

In the example construction shown in FIG. 1, the sheet 10 may include a first or base layer 20a of the flexible material that can be formed (e.g., poured) as a base on which the rigid panels 12, 14 are placed and spaced from each other to permit the additional flexible material to be added therebetween to create the flexible portion 18. The sheet 10, in some example implementations, may further include a second or top layer 20b that may be poured or otherwise formed over the entire sheet 10 (i.e., the rigid panels 12, 14 coupled via the flexible material 18). The base layer 20A and the top layer 20B may, for example, encapsulate the rigid panels 12, 14 and the flexible portion 18 therein.

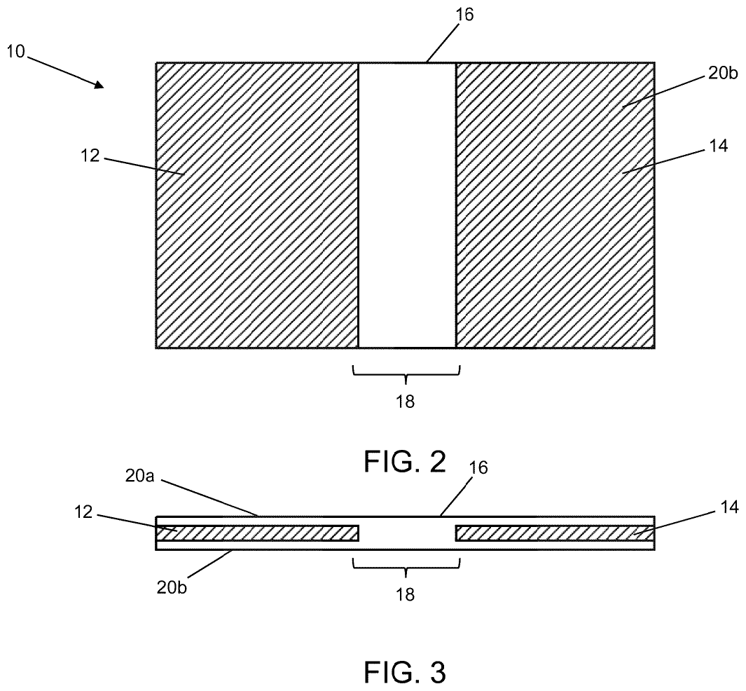

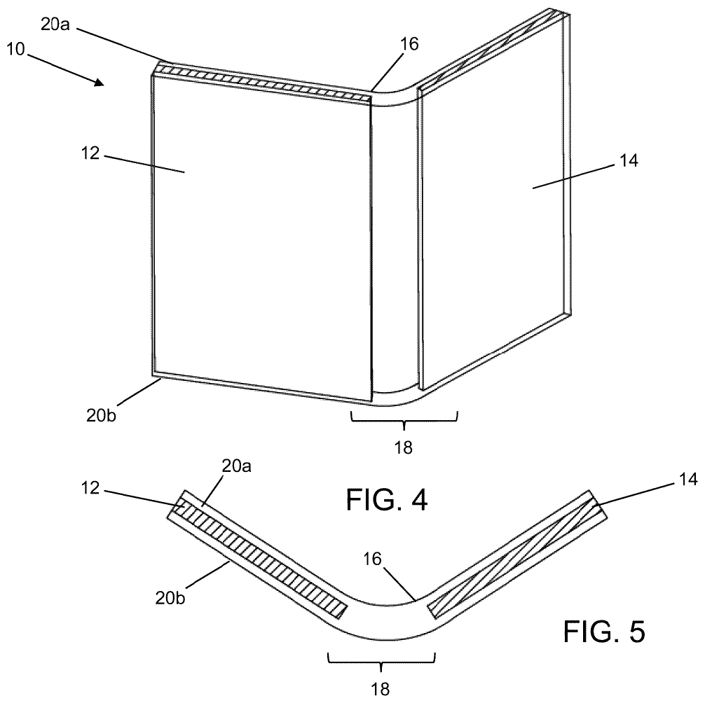

FIG. 2 illustrates a plan view of the sheet 10 with the rigid panels 12, 14 being visible through, for example, a transparent second or top layer 20b. The example edge view shown in FIG. 3 illustrates the encapsulation of the rigid panels 12, 14 and the flexible portion 18 between the panels 12, 14 within the base layer 20A and the top layer 20b of flexible material 16. FIGS. 4 and 5 provide perspective and edges views respectively, of the example sheet 10 when flexed, to illustrate the flexibility of the sheet 10 about and as a result of inclusion of the flexible portion 18. As detailed further below, a product constructed or otherwise produced from the sheet 10 can inherit this flexibility, for example, by aligning a flexible portion of that product with the flexible portion 18 of the sheet 10.

According to various implementations, the rigid panels 12, 14 can be formed from any suitable rigid material, including, but not limited to, acetate sheets, rigid plastics, metal, or other thin rigid materials. In some examples, the rigid panels 12, 14 can be pre-formed and cut into desired shapes or may alternatively be poured in layers. The flexible material 16 can be constructed from one or more of an elastomer such as thermoplastic polyurethane (TPU), rubber or thermoplastic rubber (TRP), soft plastic, or any other suitable material known in the art.

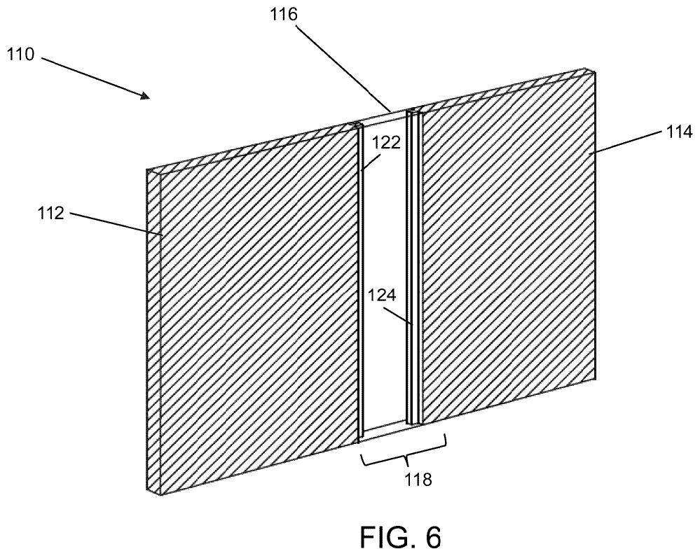

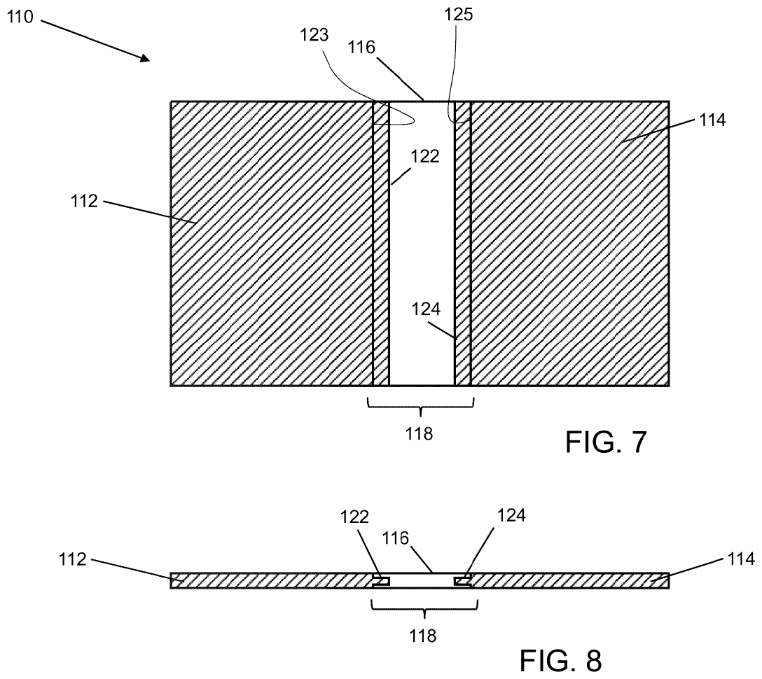

It will be appreciated that the integration of the rigid and flexible portions of the sheets described herein can vary in many ways. For example, FIGS. 6-10 illustrate another configuration in which a sheet 110 is constructed without the base layer 20a and the top layer 20b, as provided in the example shown in FIGS. 1-5. In some implementations, such as that shown in FIGS. 6 to 10, the sheet 110 includes a first rigid panel 112 having a first tab or other protrusion 122 protruding outwardly from one or more edges of the first rigid panel 112. Similarly, the sheet 110 includes a second rigid panel 114 having a second tab or other protrusion 124 protruding outwardly from one or more edges of the second rigid panel 114. In one example, the first tab 122 and the second tab 124 protrude outwardly from an inner edge 123 and 125 of the first rigid panel 112 and the second rigid panel 114, respectively, that faces the open space between the rigid panels 112, 114. In one example, the first tab 122 protrudes from the inner edge 123 of the first rigid panel 112 towards the second rigid panel 114, and the second tab 124 protrudes from the inner edge 125 of the second rigid panel 114 towards the first rigid panel 112. The protrusions or tabs 122, 124 provide additional surface area for bonding the rigid panels 112, 114 to the flexible material 116 poured or otherwise formed between the panels 112, 114 to create a flexible portion 118 that is bonded or otherwise coupled or attached to both panels 112, 114. As with the example shown in FIGS. 1-5, the example shown in FIGS. 6-10 includes a flexible portion 118 that creates a transverse strip across the sheet 110. FIG. 8 illustrates the additional bonding area provided by the protrusions 122, 124, by the flexible material 116 being poured or otherwise added to fill the gap between the rigid panels 112, 114.

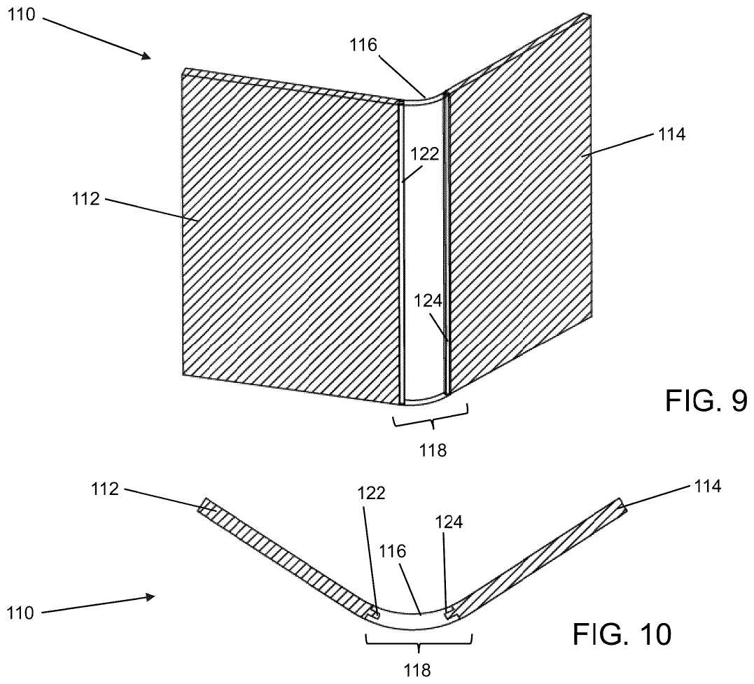

FIGS. 9 and 10 illustrate the flexibility of the sheet 110 enabling products produced therefrom to inherit the same flexibility when aligned with the flexible portion 118.

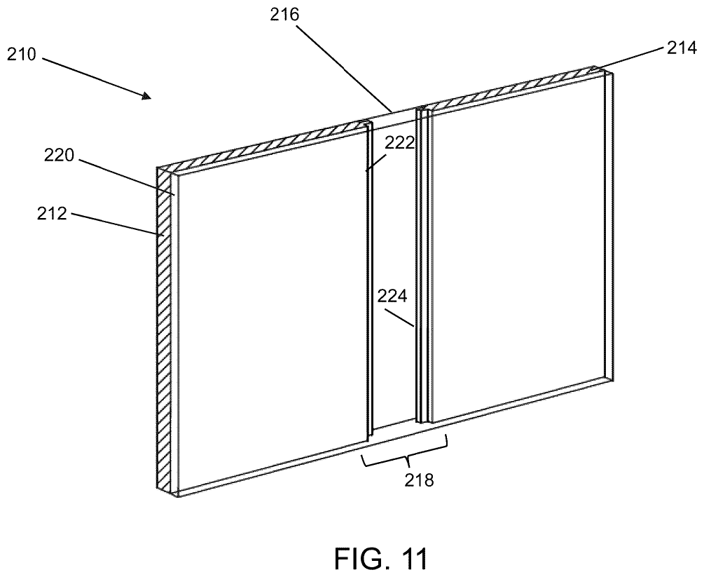

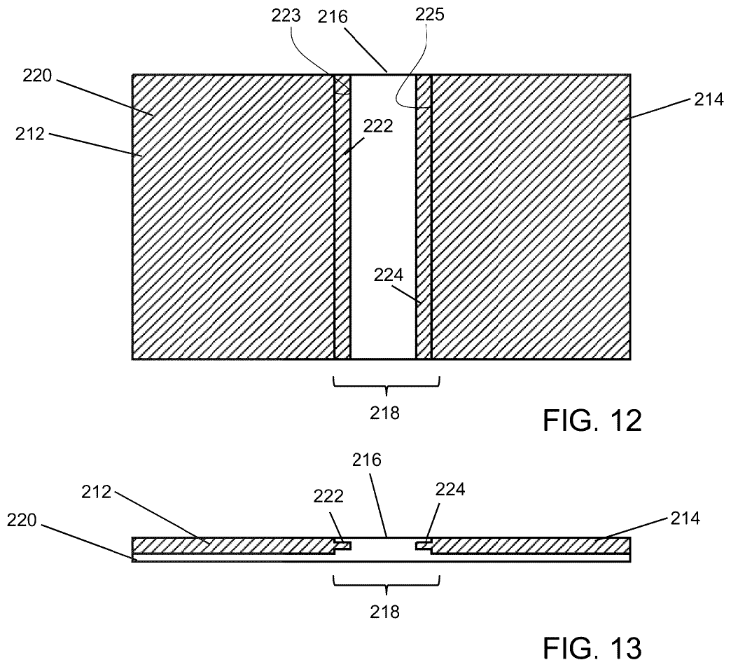

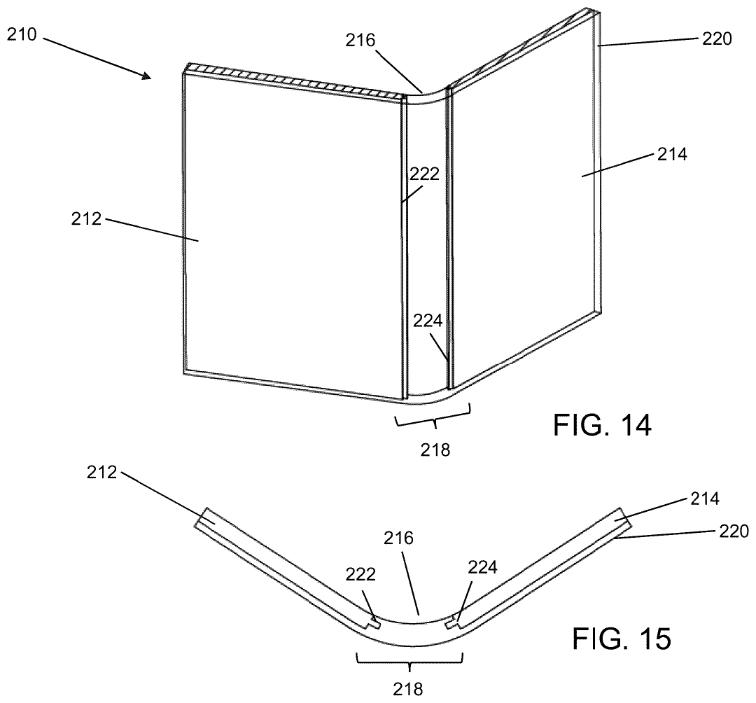

FIGS. 11-15 illustrate yet another example configuration in which a sheet 210 is constructed using first and second protrusions 222, 224 and a layer 220 of the flexible material 216 over first and second rigid panels 212, 214. In some implementations, as seen in FIGS. 12 and 13, the protrusions 222, 224 can also be configured to project from, for example, a central part of the inner edges 223, 225, of the panels 212, 214 to enable the flexible material 216 to bond to both sides thereof, thereby increasing the bonding surface area for the flexible material 216. The layer 220 can be poured or otherwise added to the upper surfaces of the rigid panels 212, 214 and fill the gap or void between the rigid panels 212, 214, creating the flexible portion 218, as best seen in FIG. 13. FIGS. 14 and 15 illustrate the flexibility of the sheet 210, enabling the products constructed or otherwise produced from the sheet 210 to inherit the same flexibility when aligned with the flexible portion 218.

It can be appreciated that having the protrusions 122/124, 222/224 is optional and that each of the protrusions may be implemented in any shapes, sizes and/or configurations. Moreover, the layers 20a/20b, 220, while illustrated as being uniform with the flexible material 16/116/216 that forms the flexible portion 18, 118, 218, can instead be added as separate layers on the sheets. That is, for example, in the embodiment shown in FIGS. 1-5, the first layer 20a can be formed separately from the material 16 filling the void and creating the flexible portion 18 with the second layer 20b added atop the upper surfaces of the rigid panels 12, 14 and the flexible portion 18.

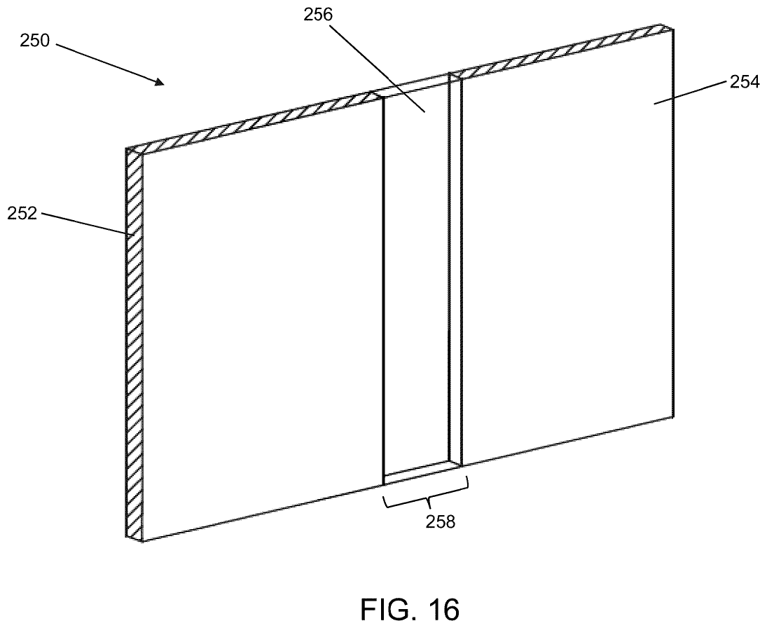

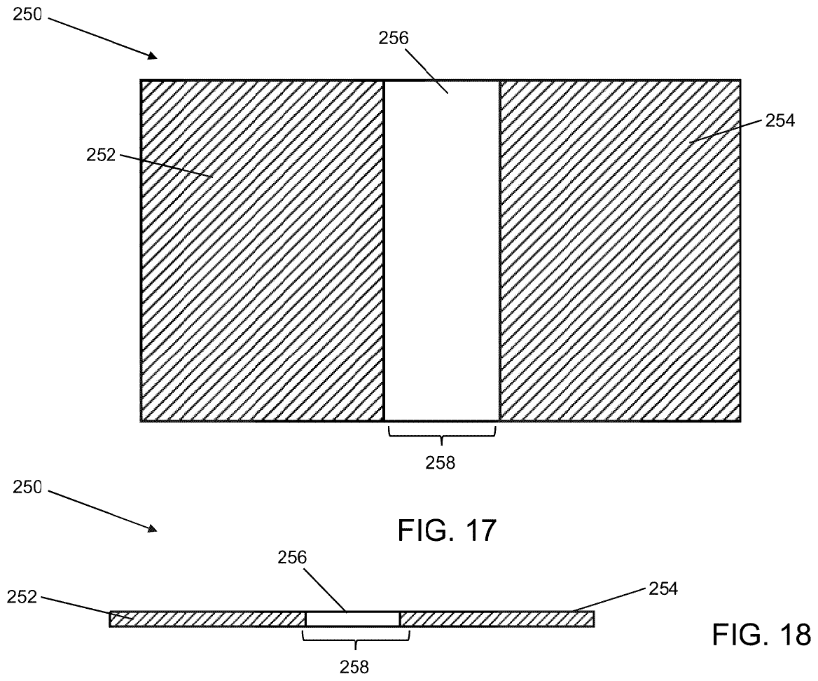

FIGS. 16-18 illustrate yet another example configuration in which a sheet 250 is constructed without any protrusions but with a layer 256 of the flexible material 256 between first and second rigid panels 252, 254. As seen in FIGS. 17 and 18, the flexible material 256 is able to bond to inner edges of the rigid panels 252, 254 in the central flexible portion 258. The flexible material 256 can be poured or otherwise added between the rigid panels 252, 254 to fill the gap or void between them, thereby creating the flexible portion 258, as best seen in FIG. 18. As such, it can be appreciated that the flexible material 256 can be added to a void between the panels 252, 254 with or without any protrusions or portions besides the cut or machined edge of the rigid panels 252, 254. The sheet 250, as constructed in FIG. 17 can also flex in a similar manner as shown in FIG. 15.

Referring now to FIG. 19, an example first template 50 for a product is shown applied to the sheet 10. It may be appreciated that the template being applied to the sheet 10 is only an example, and that any other sheet described in this disclosure may be used in a similar manner without deviating from the scope of claimed subject matter. In this example, the template 50 corresponds to an eyewear frame having a first lens retainer 52a for supporting a first lens therein and a second lens retainer 52b for supporting a second lens therein. The first and the second lens retainers 52a, 52b may be coupled together via a central bridge portion 54. The template 50 is applied to the sheet 10 such that the central “bridge” portion of the eyewear frame aligns with the flexible portion 18 of the sheet 10. In this way, when the template 50 is used to machine the sheet 10 to extract the eyewear frame, the eyewear frame inherits the flexibility of the flexible portion 18, in what is now a flexible bridge portion of the eyewear frame. Similarly, the resultant first and second lens retainers of the eyewear inherit the rigidity of the rigid portions of the sheet 10.

FIG. 19 also illustrates an example second template 60 for a product. In this example the template 60 corresponds to an eyewear arm or temple portion that supports the eyewear on user's ears. The template 60 is also applied to the sheet 10 such that a central portion of the arm aligns with the flexible portion 18 of the sheet 10. In this way, when the sheet 10 is machined to extract the eyewear arm according to the template 60, the arm inherits the flexibility of the flexible portion 18 in what is now a flexible mid portion of the arm that permits the arm to flex against a wearer's head.

While the examples shown in FIG. 19 relate to eyewear components, it can be appreciated that the sheet 10/100/200 can be used to impart a hybrid or combination of rigid and flexible portions to any product that can suitably use the materials used to create the sheet 10/100/200. For example, flexible tools and instruments that would include one or more rigid components coupled to one or more flexible components.

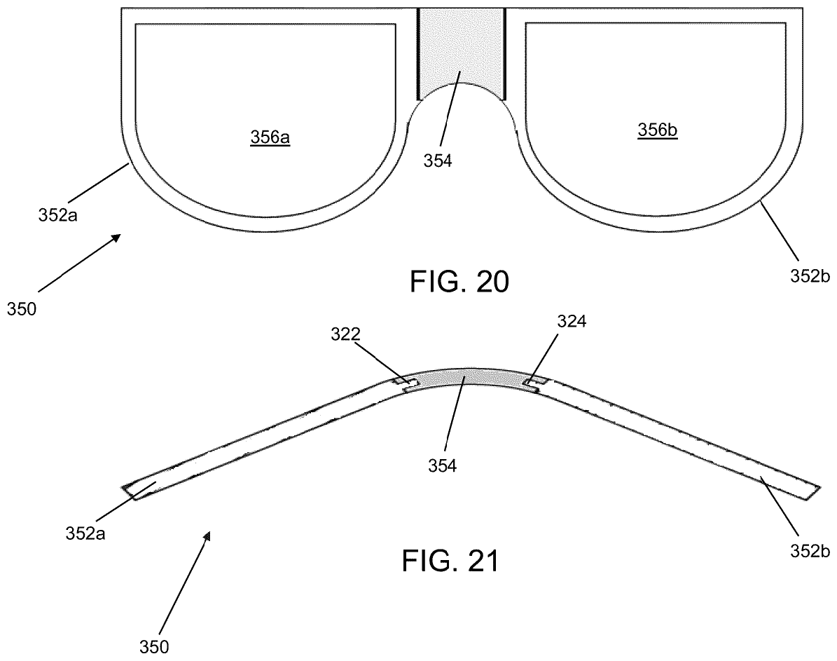

The templates 50, 60 are merely examples of designs for products that can be used to generate the products from the sheets 10, 100, 200 and are particularly suitable for using the sheets 10, 100, 200. The products, such as the eyewear frame and eyewear arm shown in FIG. 19 can be generated by machining the sheet 10 according to the template 50, 60 to remove the excess material. As such, the sheet 10 may be optimized by including as many products or units of product on the same sheet 10 as possible, to minimize waste material. When machined or otherwise cut from the sheet 10 according to the template 50, a resulting eyewear frame 350 is obtained as shown in FIG. 20. In this example, the eyewear frame 350 includes a first rigid lens holder 352a for holding a first eyewear lens 356a and a second rigid lens holder 352b for holding a second eyewear lens 356b. The rigid lens holders 352a, 352b are coupled to each other via a flexible bridge portion 354 that is included by virtue of extracting the frame 350 from the sheet 10 according to the template 50 shown in FIG. 19. In this way, the flexible bridge portion 354 can be included in the eyewear frame 350 without the need for additional assembly steps or complex joining or coupling mechanisms or assemblies.

FIG. 21 illustrates the flexibility of the eyewear frame 350 akin to the flexibility of the sheets 10, 100, 200 as illustrated in FIGS. 5, 10, and 15.

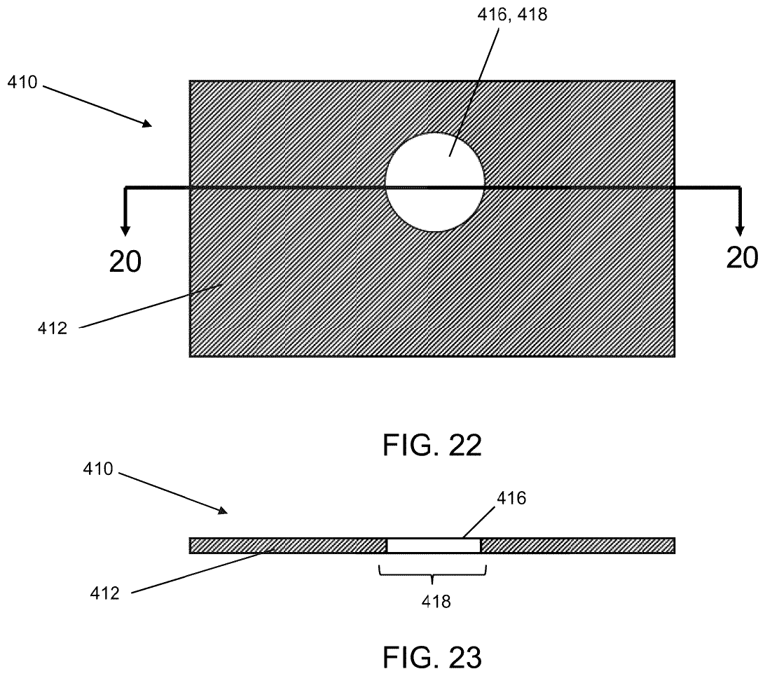

FIG. 22 illustrates another configuration for a rigid sheet 410 which includes a single panel 412 having a portion removed. In this example a centrally-located round opening 418 is filled with the flexible material 416 or the flexible material 416 is otherwise added or inserted into the opening 418. While in FIG. 22 a single panel 412 is shown, it can be appreciated that multiple panels (not shown) can be assembled to abut each other so as to arrive at what is shown in FIG. 22 but from multiple panels. FIG. 23 illustrates a cross-section along line 20-20 in FIG. 22 to illustrate the interfaces between the flexible material 416 and the panel(s) 412. The sheet 410 and its cross-section are only an example and the same principles can be applied to other cross-sections such as the sheets 10, 110, 210, 250 shown in FIGS. 3, 8, 13, and 18. The embodiment illustrates in FIGS. 22 and 23 therefore demonstrates that the flexible portion 18, 118, 218, can be implemented in any size, shape and proportion of the sheet 10, 110, 210 and need not be limited to a strip between a pair of panels 12, 14.

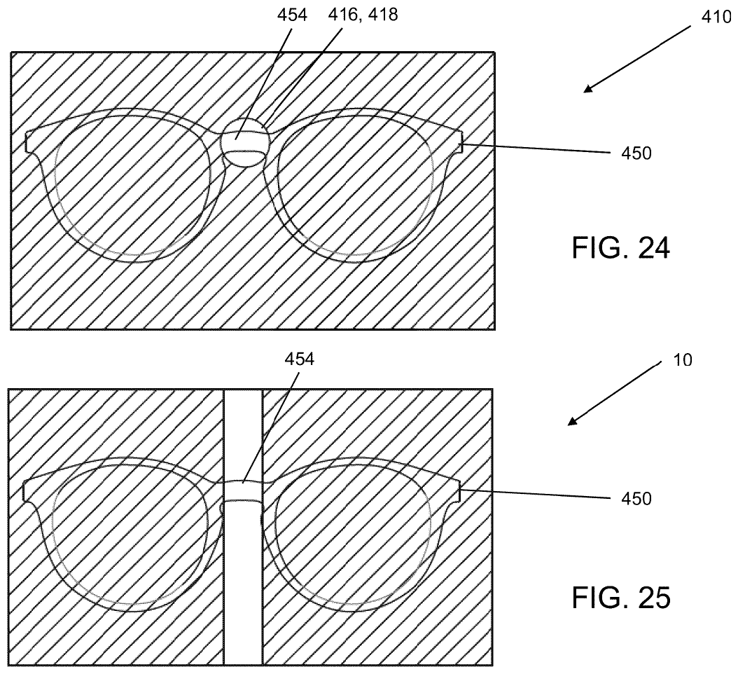

FIG. 24 illustrates an eyewear pattern 450 applied to the sheet 410 with a flexible portion 454 of the eyewear being aligned with the flexible portion 416, 418 of the sheet 410. For the sake of comparison, in FIG. 25, the same eyewear pattern 450 is shown being applied to a sheet 10 such as that shown in FIGS. 1 and 16 to demonstrate that the same pattern can be applied to multiple ones of the embodiments shown herein and need not be limited to any one configuration.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in or related to the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A sheet material comprising:
a rigid portion defining an opening; and
a flexible material received within the opening and adapted to attach with the rigid portion to form a flexible portion of the sheet material.

2. The sheet material of claim 1 further comprising a first layer of flexible material and a second layer of flexible material, and wherein the rigid portion attached to the flexible material is placed between the first and second layer of flexible material.

3. The sheet material of claim 1, wherein the rigid portion includes a tab protruding therefrom into the opening, the tab being adapted to provide an additional surface for attachment with the flexible material received within the opening.

4. A composite sheet material for constructing a product therefrom, the composite sheet material comprising:
a first rigid panel;
a second rigid panel spaced apart from the first rigid panel to define an open space therebetween; and
a flexible material received in the open space and adapted to attach to each of the first and second rigid panels for coupling the rigid panels together, the flexible material forming a flexible portion of the composite sheet material to provide flexibility to the product constructed using the composite sheet material.

5. The composite sheet material of claim 4 comprising a base layer of flexible material and wherein the first and rigid panels are placed on the base layer to be spaced apart and define the open space therebetween.

6. The composite sheet material of claim 4 comprising a top layer of flexible material formed over the first and second rigid panels coupled via the flexible material.

7. The composite sheet material of claim 4, wherein each of the first and second rigid panels includes a respective tab protruding outwardly towards the open space, and wherein each tab provides an additional surface area for bonding the respective first and second rigid panels to the flexible material.

8. The composite sheet material of claim 4, wherein the first and the second rigid panels are made of one or more of rigid plastic material, acetate, and metal.

9. The composite sheet material of claim 4, wherein the flexible material is one or more of soft plastic, rubber, thermoplastic rubber (TRP), thermoplastic polyurethane (TPU) and elastomer.

10. The composite sheet material of claim 4, wherein the product is an eyewear comprising a first and second lens retainer and a flexible bridge portion connecting the first and second lens holders, and wherein the eyewear is constructed by aligning and forming the flexible bridge portion with the flexible portion of the composite sheet.

11. A product template applied over the composite sheet material of claim 4 for extracting the product therefrom.

12. A method of making a composite sheet material, the method comprising:
providing a first rigid panel and a second rigid panel spaced apart to define an open space therebetween; and
filling the open space with a flexible material adapted to attach to each of the first and second rigid panel, the flexible material filled in the open space forms a flexible portion of the composite sheet material to provide flexibility to the product constructed using the composite sheet material.

13. The method of claim 12, wherein each of the first rigid panel and the second rigid panel includes a respective tab protruding outwardly towards the open space, and wherein each tab provides an additional surface area for bonding the respective first and second rigid panels to the flexible material.

14. The method of claim 12 comprising providing a base layer of flexible material and wherein the first and rigid panels are placed on the base layer to be spaced apart and define the open space therebetween.

15. The method of claim 12 comprising forming a top layer of flexible material formed over the first and second rigid panels coupled via the flexible material.

16. A method of constructing an eyewear from a composite sheet material, the eyewear comprising a first lens holder and a second lens holder coupled to the first lens retainer via a bridge portion, the method comprising:
providing the composite sheet material including a first rigid panel and a second rigid panel coupled to the first rigid panel via a flexible material;
applying a template for the eyewear over the composite sheet material such that the bridge portion of the eyewear template aligns with the flexible material of the composite sheet material; and
processing the composite sheet material according to the template to extract the eyewear having the first lens holder and the second lens holder made from the rigid panels of the composite sheet material and the bridge portion made from the flexible material of the composite sheet material.

17. The method of claim 16, wherein the first and the second rigid panels are made of one or more of rigid plastic material, acetate, and metal.

18. The method of claim 16, wherein the flexible material is one or more of soft plastic, rubber, thermoplastic rubber (TRP), thermoplastic polyurethane (TPU) and elastomer.

19. The method of claim 16, wherein the composite sheet material is processed by machining or cutting.
